(19) United States
(12) Patent Application Publication
(10) Pub. No.: US 2012/0176694 A1
(43) Pub. Date: Jul. 12, 2012

(54) Heliostat System

(75) Inventors: Zvi Gershony, San Jose, CA (US); Ross Koningstein, Atherton, CA (US); William H. Whitted, Woodside, CA (US)

(73) Assignee: Google Inc., Mountain View, CA (US)

(21) Appl. No.: 13/107,777

(22) Filed: May 13, 2011

Related U.S. Application Data
(63) Continuation-in-part of application No. 12/967,629, filed on Dec. 14, 2010.

(51) Int. Cl. G02B 5/10

(52) U.S. Cl. 359/853

(57) ABSTRACT

A heliostat system includes a base member adapted to be secured to a fixed surface, a transitional member that is formed as a substantially unitary member and a mirror member. The transitional member is coupled to the base member and to the mirror member. The mirror member includes a support portion coupled to the transitional member and a mirror portion. A first bearing coupling the base member and the transitional member provides relative changes in azimuth between the base member and the transitional member. A second bearing coupling the transitional member and the mirror member provides relative changes in elevation between the transitional member and the mirror member. A drive system rotates the transitional member about the first bearing and the mirror member about the second bearing to change the azimuth and the elevation of the mirror member.

### CROSS REFERENCE TO RELATED APPLICATION

This application is a continuation-in-part of pending U.S. application Ser. No. 12/967,629, entitled “Layered Mirror Assembly” filed on Dec. 14, 2010 by John S. Fitch et al., the entire contents of which application is incorporated herein by reference.

### TECHNICAL FIELD

This specification relates to a heliostat system.

### BACKGROUND

Heliostats can be used to collect radiation from the Sun. Specifically, a heliostat can include one or more mirrors to direct solar rays toward a receiver mounted on a receiver tower. Some types of heliostats are capable of moving their mirror or mirrors as the Sun moves across the sky, both throughout the day and over the course of the year, in order to more efficiently direct solar rays to the receiver. Solar rays that are directed to the receiver can then be used to generate solar power. A field of heliostats can be placed surrounding one or more receivers to increase the quantity of radiation collected and optimize the amount of solar power that is generated. The solar power is converted to electricity by either the receiver or a generator that is coupled to the receiver.

A typical heliostat includes a system to control and point the mirror. Because the typical heliostat offers very low inertia (hence low resistance to fast perturbations) relative to its wind-exposed surface area, small, rapidly rising, asymmetric gusts of wind can easily move these light structures slightly off their intended targets. For similar reasons, mechanical or sound vibrations have a deleterious impact on short-term system pointing accuracy. A stabilization technique can employ some form of position feedback to constantly monitor and adjust the mirror's angle using the heliostat's positioning prime-movers. Typically, this results in the mirror position being constantly a bit off position and requires a near continuous, small-scale slewing back and forth of the prime-mover. Such constant adjustment, especially because of its bi-directional nature, can use a substantial amount of energy to provide the start-stop-reverse accelerations required.

### SUMMARY

In general, in one aspect, a heliostat system is described that includes a base member adapted to be secured to a fixed surface (e.g., the Earth), a transitional member and a mirror member. A lower portion of the transitional member is coupled to the base member and an upper portion of the transitional member is coupled to the mirror member. The transitional member is formed as a substantially unitary member. The mirror member includes a support portion and a mirror portion, wherein the support portion is coupled to the transitional member. The heliostat system further includes a first bearing coupling the base member and the transitional member. A lower portion of the first bearing is included in the base member and an upper portion of the first bearing is included in the transitional member. The heliostat system further includes a second bearing coupling the transitional member and the mirror member. A first portion of the second bearing is included in the transitional member and a second portion of the second bearing is included in the support portion of the mirror member. The heliostat system further includes a drive system that is configured to rotate the transitional member about the first bearing and to rotate the mirror member about the second bearing to change the azimuth and the elevation of the mirror member.

These and other embodiments can each optionally include one or more of the following features. The mirror member can be formed from a high density material, e.g., a cementitious material. The first bearing can be a thrust bearing and the drive system can include a motor to drive the thrust bearing. The second bearing can be a goniometric cradle bearing and the drive system can include a motor to drive the goniometric cradle bearing. The drive system can include a first drive sub-system to drive the first bearing and a second drive sub-system to drive the second bearing. The base member can include a pole mounted within the Earth. The base member can be affixed to a concrete pad formed on the Earth. The mirror portion can be a mirror formed substantially from cementitious material and include a reflective layer, and the support member can be formed substantially from the cementitious material. The transitional member can be formed from cementitious material. The base member can be formed from cementitious material. A rotational centerline of each of the base member, transitional member and mirror member can pass through the respective member's center of gravity.

In general, in another aspect, a heliostat system is described that includes a base member, a transitional member and a mirror member. The base member is adapted to be secured to a fixed surface (e.g., the Earth) and a lower portion of a thrust bearing is included at a distal portion of the base member. The transitional member is formed as a substantially unitary member cast from a high density material. An upper portion of the thrust bearing is included at a lower portion of the transitional member, which is coupled to the base member. A lower portion of a goniometric cradle bearing is included at an upper portion of the transitional member, which is coupled to the mirror member. The mirror member includes a support portion and a mirror portion. The support portion includes an upper portion of the goniometric cradle bearing and is coupled to the transitional member. The heliostat system further includes a drive system that is configured to rotate the transitional member about the thrust bearing and to rotate the mirror member about the goniometric cradle bearing to change the azimuth and the elevation of the mirror portion of the mirror member.

In some implementations, a rotational centerline of each of the base member, transitional member and mirror member passes through the respective member's center of gravity. The mirror member can be formed from a high density material, e.g., a cementitious material. The transitional member and/or the base member can be formed from a cementitious material.

Particular embodiments of the subject matter described in this specification can be implemented so as to realize one or more of the following advantages. The mirror described can be formed with sufficient mass to resist the effects of wind and mechanical vibrations, yet be formed at a relatively low cost. The mirror can be formed with a curvature or other shape to accommodate a particular application. A heliostat system can be provided that minimizes the effects of winds and mechanical vibrations, allowing for more accurate and consistent positioning of the heliostat mirror. The heliostat system can be manufactured using relatively low cost materials and can be more easily assembled than prior art systems, thereby reducing installation costs. The common practice is to assemble a heliostat from a number of disparate elements, which practices often result in lost economies of common structure. By comparison, in the unified heliostat disclosed herein, one component may provide multiple functions, as compared to the more typical prior art heliostat where several individual components may be necessary to provide the same level of functionality. The heliostat described herein can be made with reduced assembly time, decreased parts inventory and generally an increased mean time between failures (MTBF). The heliostat can be used in concentrating solar thermal plants or other applications where a low-cost means of redirecting sunlight with high angular accuracy, particularly in the presence of winds and/or vibration, is desired.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIGS. 1A and 1B show an example heliostat.

FIG. 2A shows a schematic representation of a portion of an example mirror in a cutaway view.

FIG. 2B shows a schematic representation of a cross-sectional view of the example mirror of FIG. 2A.

FIG. 3 is a flowchart showing an example process 300 for manufacturing a mirror as shown in FIGS. 2A and 2B.

FIG. 4 is a block diagram representation of a heliostat system 400.

Like reference numbers and designations in the various drawings indicate like elements.

### DETAILED DESCRIPTION

Typical prior art heliostat mirrors are made of glass or polymer substrates with subsequent reflective layers added. Such mirrors offer little mechanical strength and therefore most often mounted to some secondary supporting structure, e.g., an aluminum frame. The need for this secondary structure adds material, labor and complexity that may be unacceptable in cost-sensitive applications, e.g., a large-scale concentrating solar power installation. Mirrors constructed on glass substrates are easily broken when exposed to common environmental hazards, such as strong winds or large hail stones. Protecting such mirrors from these hazards generally adds additional components and cost. Polymer substrate mirrors often suffer from reduced reflectivity as compared to glass equivalents. These mirrors too can be rendered unserviceable by high winds and may become brittle or optically occluded after long exposure to high levels of ultraviolet light as are commonly present in solar energy applications. The operations commonly employed in forming either of these mirror types into large focusing optical elements add a layer of complexity, cost and opportunity for the loss of reflective quality. This can be more of a problem with two axes of curvature mirrors (e.g. paraboloids of rotation) than those curved along only one axis (troughs), but both offer challenges to their manufacturers and users.

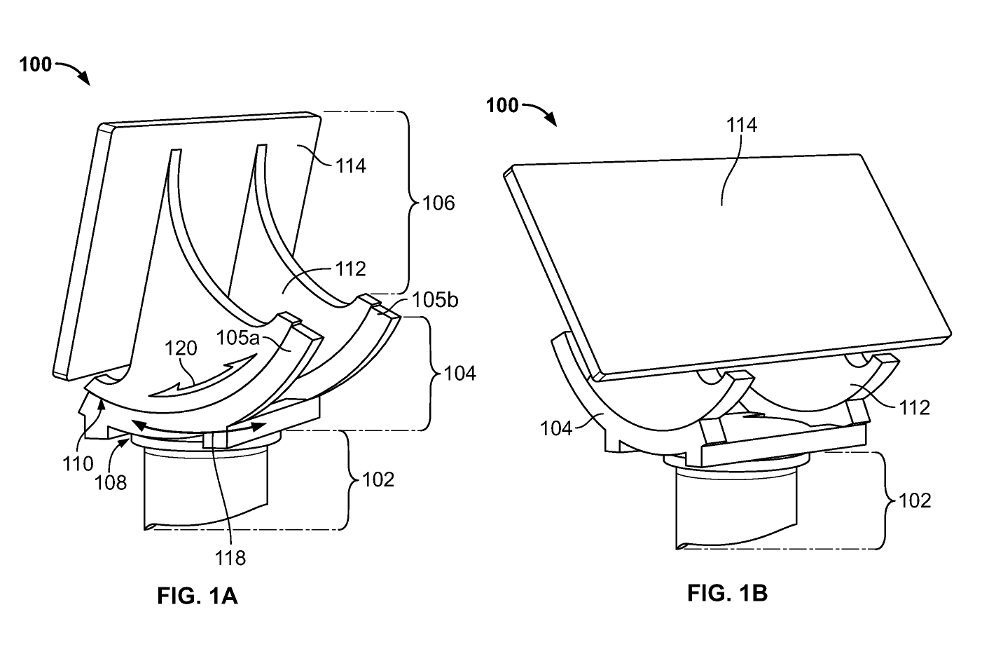

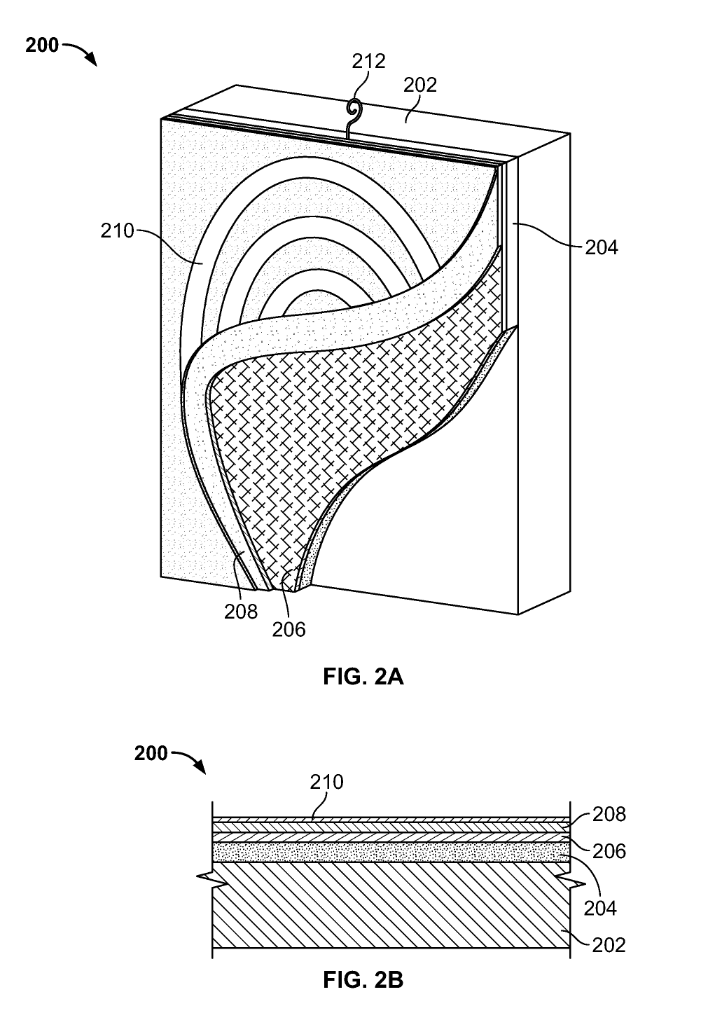

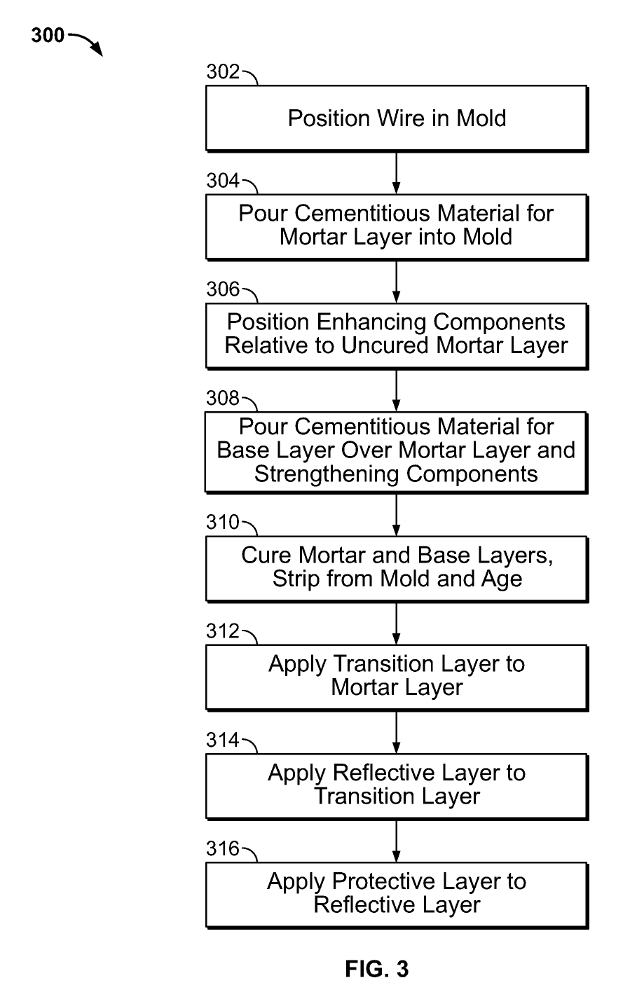

FIGS. 1A and 1B show an example heliostat 100. The heliostat 100 includes a base member 102, a transitional member 104 and a mirror member 106. The heliostat 100 is described in further detail below. However, it provides an example system where a mirror included in the mirror member 106 (or mounted thereto), can be formed as described below in reference to FIGS. 2A, 2B and 3. FIG. 2A shows a schematic representation of a portion of an example mirror 200 in a cutaway view. The mirror 200 can be integrated during the manufacturing process with existing components of a heliostat. By way of illustrative example, the mirror 200 can form the mirror portion 114 of the mirror member 106 shown in the example heliostat 100. The heliostat mirror includes a concrete or cementitious base and multiple other layers as shown, such that a sturdy and environmentally stable reflective surface is created. The mirror 200 can have sufficient weight and volume to resist movement by wind. However, the weight can be kept to a suitable level to still allow the mirror 200 to be moved about various degrees of freedom, so as to track the movement of the Sun throughout the course of a day.

FIG. 2B shows a schematic representation of a cross-sectional view of the example mirror of FIG. 2A. In the implementation shown, the mirror 200 includes five layers 202-210. The mirror includes a base layer 202 that can be formed from a cementitious material, e.g., cement or concrete. A mortar layer 204 can be formed from a cementitious material that includes one or more additives that modify the properties of the material. The thickness of the mortar layer 204 can depend on material strength and the loads expected to be resisted by the mirror. The base layer 202 is the thickest layer. In some implementations, the base layer 202 includes hollowed out areas to reduce the volume of the material and therefore the weight and cost of the base layer 202. In an example implementation, the base layer 202 is approximately 1 to 3 inches thick. The mortar layer 204 can have more requirements to meet than the base layer 202, e.g., binding to the base layer 202, precision surface, chemical compatibility to the transition layer 206 and/or electrical conductivity, and therefore can be formed from a more expensive material than the base layer 202. However, keeping the mortar layer 204 relatively thin as compared to the base layer 202 can help reduce the overall cost of the mirror. In implementations where the mirror is large and curved, the base layer 202 can be formed in a crude curve shape and the thickness of the mortar layer 204 can be selected such that the mortar layer can be used as an interface and a precision layer, while keeping material and manufacturing costs down.

A transition layer 206 is included between the mortar layer 204 and a reflective layer 208. The reflective layer 208 provides the reflective component of the mirror 200. A protective layer 210 is substantially transparent and offers protection to the reflective layer 208, e.g., to reduce corrosion and other deleterious effects that exposure to the outdoors can have on the reflective layer 208. Some particular examples of how the layers can be formed are described below.

Plating

In some implementations, the mortar layer 204 is a moderately thin layer of mortar that can be a cementitious material, e.g., concrete or cement. The mortar layer 204 can be molded in a form having a geometry appropriate to the intended purpose of the mirror, e.g., having a concave surface so that the reflective layer 208 acts to focus light, and can include one or more additives that modify the cementitious material. For example, an additive can provide electrical conductivity, such that the conductivity of the layer 204 is sufficient to allow the mortar layer 204 to act as a cathode during subsequent electro-deposition processes. Additional additives in the form of chemical dispersants, wetting agents, additives to provide a moisture barrier against efflorescence and/or cure-rate controls can be added to the mortar layer 204 to further enhance the finish properties of the cast optical surface. The composition of the mortar layer 204 can avoid aggregate and minimize sand, so as to improve the as-cast surface finish of the molded part.

A conductive wire 212 can be molded into the bulk of the mortar layer 204 and provide an electrical connection to complete a current path between this mortar layer 204 acting as a cathode and a plating power supply (not shown). While the mortar layer 204 is still uncured and in its mold, the base layer 202 can be cast directly onto the mortar layer 204, thereby forming a permanent bond between the two layers 202 and 204. The base layer 202 provides a sturdy structural base for the mirror 200, while providing rigidity and strength to maintain a desired optical shape and to offer the potential for becoming a direct connecting member between the reflective surface and any mounting or positioning elements. Not shown, but integral to the pour of base layer 202 can be one or more enhancing components. The enhancing components can be included in the base layer 202 to enhance one or more properties of the base layer 202, including, for example, the strength, weight and/or cost of the layer 202. Examples of enhancing components includes a matrix of wire mesh, glass or polyester matting, sand, large and small aggregate, beads, foam and/or other materials as commonly used to strengthen or lighten cast concrete. For example, in some implementations, the base layer 202 can be a foamed concrete so that less concrete is required, therefore reducing the cost and weight of the mirror 200.

The transition layer 206 represents one or more thin layers of electro-deposited metal, for example, copper. The transition layer 206 can fill small voids or surface cracks in the cast concrete surface of mortar layer 204. The coating can be applied after the concrete composite (i.e., layers 202 and 204) is cured, stripped from its mold and aged.

The reflective layer 208 is a thin layer of metal electro-deposited over the transition layer 206. Some example metals include silver and aluminum. The reflective layer 208 provides the reflective surface for the mirror 200.

The protective layer 210 is a protective layer formed of a transparent material, for example, clear varnish or some other thin, transparent material. In some implementations, the layer is formed from liquid glass (e.g., sodium silicate). The protective layer 210 can be sprayed onto the mirror, can be applied by dipping or otherwise formed. The protective layer 210 can prevent the oxidation of the underlying metal (e.g., the silver or aluminum), which would otherwise suffer corrosion damage over time. However, in some implementations, the protective layer 210 can be formed by anodizing some of the reflector material, e.g., aluminum, to form an aluminum oxide layer.

Precipitation

In some implementations, the layers 202, 204 and 210 can be formed as described above, however, layers 206 and 208 can be formed as follows. The transition layer 206 can be a thin layer of liquid glass (e.g., sodium silicate) deposited on the concrete surface of mortar layer 204 by vapor deposition, spraying or dipping. The glass transition layer 206 further enhances the optical quality of the concrete transition layer 206, by filling up voids and cracks resulting from the concrete curing process, and provides a good surface for chemical reactions for elemental reflective coating deposition to form reflective layer 208. The reflective layer 208 is a thin layer of elemental reflective material applied to the assemblage of the base layer 202, 204 and 206. The reflective layer 208 provides the reflective surface of the mirror 200. By way of example, the reflective layer 208 can be formed of silver or aluminum and can be applied by chemical precipitation, plasma or vapor deposition.

Conformal Coating

In some implementations, the layers 202, 204 and 210 can be formed as described above, however, layers 206 and 208 can be formed as follows. The transition layer 206 represents a conformal coating. The coating can fill small voids or surface cracks in the cast concrete surface of mortar layer 204, and can also function as an impermeable barrier, protecting the mirror metal(s). The coating can be applied after the concrete composite (i.e., layers 202 and 204) is cured, stripped from its mold and aged. In some implementations, the conformal coating is an epoxy-based coating.

The reflective layer 208 is a thin layer of elemental silver applied to the assemblage of layers 202, 204 and 206. This reflective layer 208 provides the reflective surface for the mirror 200. By way of example, the reflective layer 208 can be formed of silver or aluminum and can be applied by chemical deposition (e.g., precipitation), plasma (thermal spraying) or vacuum deposition.

Thin Mirror Adhered to Glass-Protected Base

In some implementations, the layers 202, 204 and 210 can be formed as described above, however, layers 206 and 208 can be formed as follows. The transition layer 206 can be a thin layer of liquid glass (e.g., sodium silicate) deposited on the concrete surface of mortar layer 204 by vapor deposition, spraying or dipping. The reflective layer 208 is a thin mirror that is adhered onto the transition layer 206, for example, by gluing the mirror to the transition layer 206 using a mortar. An example mortar is low-shrinkage poly-methyl-methacrylate (PMMA) mortar, although other types of mortar can be used.

The specific materials, additives and manufacturing methodologies may be different as suits the specifics of the manufacturing process, place and end use of the mirror. While concrete and conductive concrete (as appropriate) can be used as described above, many other moldable materials offering the strength, stiffness and electrical properties of the concretes described here would serve just as well. For example, in some implementations a coated steel stamping can be used in place of concrete. While copper and silver electro-deposition can be used, for example, in an implementation where the mirror is used for concentrating solar energy, the mechanical and optical properties of other metals can be appropriate for this or other reflective uses. For example, aluminum is also a good reflector material, and can be electro-plated, plasma-sprayed or precipitated using methods described above.

The mirror 200 is described above in the context of a heliostat mirror. However, it should be understood that the mirror described can be used in other applications, and can be particularly useful for mirrors used for linear-focus or point-focus.

FIG. 3 is a flowchart showing an example process 300 for manufacturing a mirror as shown in FIGS. 2A and 2B. In this process 300, the mortar layer 204 is initially formed using a mold that is configured according to a desired shape of the mirror. For example, if manufacturing a mirror such as the mirror portion 116 shown in FIGS. 1A and 1B, a mold having that shape is used. The example mirror portion 116 shown is flat, however, in some implementations the mirror portion 116 is curved. The wire 212 can be positioned in the mold prior to filling the mold with the mortar material (Box 302). The mortar material, for example, a cementitious material with one or more optional additives included, is poured into the mold (Box 304).

One or more enhancing components that will be included in the base layer 202 are positioned relative to the mortar layer 204, which is still in the mold (Box 306). For example, the enhancing components can include one or more of the following to enhance the strength and/or the weight (e.g., making the mirror lighter) and/or cost (e.g., reduce the cost of material): a matrix of wire mesh, matting (e.g., glass or polyester), sand, large and/or small aggregate, foam and/or other materials used to strengthen and/or lighten cast concrete. A cementitious material for forming the base layer 202 is poured over the enhancing components and mortar layer 204, preferably while the mortar layer is still uncured (Box 308).

In some implementations, one or more mounting features can be molded into the base layer 202. For example, if the base layer 202 will be attached to a frame or other component of a heliostat (or different system, depending on the application), mounting brackets or other hardware can be positioned accordingly, so that when the material forming the base layer is poured, the mounting features become integral to the base layer 202. The mounting features can be hardware or molded features within the base layer 202 itself, e.g., an aperture, to which hardware later can be attached. In some implementations, the base layer 202 includes ribs and corresponding grooves formed in the exposed surface, so as to reduce the volume of material used to form the base layer 202, therefore reducing the cost and the weight.

The mortar layer 204 and base layer 202 are allowed time to cure and are stripped from the mold and can be aged (Box 310). By pouring the base layer 202 onto the mortar layer 204 before the mortar layer 204 has cured, the two layers become integral to each other and have a strong bond.

The transition layer 206 is applied to the exposed surface of the mortar layer 204 (i.e., the surface that is opposite to the surface attached to the base layer 202) (Box 312). In a plating implementation, the transition layer 206 can be formed by electro-depositing a metal, such as copper, onto the surface of the mortar layer 204. In this implementation, the mortar layer 204 includes an additive providing electrical conductivity, such that the mortar layer 204 behaves as the cathode during the electro-deposition. The transition layer 206 can be formed from more than one thin layers of metal. A first layer can be applied and then one or more additional layers applied thereafter.

In a precipitation implementation, the transition layer 206 is a thin layer of liquid glass that is deposited onto the exposed surface of the mortar layer 204. The liquid class can be deposited by spraying, dipping, vapor deposition, or by another convenient technique. The liquid glass is allowed time to dry and form a substantially optically clear layer.

In a conformal coating implementation, the transition layer 206 is a conformal coating and is applied to the exposed surface of the mortar layer 204. By way of illustrative (and non-limiting) example, the conformal coating can be a parylene-based coating applied by vapor deposition. A parylene-based coating has a moisture barrier property that can be suitable to the transition layer 206.

In a thin glass implementation, the transition layer 206 can be a pre-formed thin layer of glass that is adhered to the exposed surface of the mortar layer 204. By way of illustrative (and non-limiting) examples, the glass can be pre-formed by slumping, holding the glass onto a vacuum mold, or by applying physical pressure (e.g., lay the glass over a solid or bumped surface and press it along the edge).

Once the transition layer 206 is applied, the reflective layer 208 is applied to the exposed surface of the transition layer 206 (Box 314). In a plating implementation, the reflective layer is a thin layer of metal, e.g., silver, and is applied to the transition layer 206 by electro-deposition. In a precipitation implementation, the reflective layer 208 can be a thin layer of metal, e.g., silver or aluminum, and is applied to the liquid glass forming the transition layer 206 by chemical reaction, plasma or vapor deposition. In a conformal coating implementation, the reflective layer 208 is similarly a thin layer of metal, e.g., silver or aluminum, and is applied to the conformal coating forming the transition layer 206 by chemical reaction, plasma or vapor deposition.

Once the reflective layer 208 is applied, the protective layer 210 is applied to the exposed surface of the reflective layer 208 (Box 316). In some implementations, the protective layer 210 is formed from liquid glass (e.g., sodium silicate) that is deposited on top of the exposed surface of the reflective layer 208. In other implementations, where the reflective layer 208 is formed from aluminum, the protective layer is formed by anodizing some of the aluminum reflector material to produce a layer of aluminum oxide, which forms the protective layer 210. In yet other implementations, the protective layer 210 is formed from a varnish, clear coat or other long lasting and durable transparent coating that is applied to the reflective layer 208, e.g., by spraying or dipping.

In a particular implementation, the mirror can be formed with a base layer 202 formed from concrete. The transition layer 206 is a thin glass layer (e.g., approximately 2 mm thick) bent in vacuum with a silver backing forming the reflective layer 208. An impermeable mortar/adhesive layer, e.g., a conformal coating, is applied to the reflective layer 208 to from the protective layer 210. A final coat of the thin glass layer can be laced with a fine sand such that the base layer 202 can bind to this layer (which can include the mortar layer 204).

Heliostat

Today's heliostats typically have large surface areas relative to their mass. This large “sail” area makes them especially susceptible to perturbation by wind gusts. Additionally any vibrations that may be communicated from the ground in which they're mounted into the mirror structure tends to exert a large influence on these light-weight structures. These undesirable and largely unpredictable external influences can savage the system's pointing accuracy if left unchecked. Current practice attempts to dampen or eliminate unwanted external influences use shock absorbing components, electrical or mechanical braking mechanisms and/or the continuous exercise of the system's positioning system. However, the components used in the pursuit of these damping forces are expensive to purchase and install, consume energy in their use and create additional opportunities for failures in operation. Current heliostat practice is to build with stiff and lightweight materials such as steel, aluminum and some engineering polymers. These are viewed as having desirable properties and ensure a sturdy, well-characterized and reliable connection between the mirror and its attachment to the environment. Unfortunately, these materials are much prized for these qualities and thus command a relatively high cost. Some also demand highly specialized fabrication tools and fabricating skills further increasing system manufacturing costs.

The heliostat 100 shown in FIGS. 1A and 1B will now be described in further detail. The heliostat 100 includes three components working together in such a way that a mirror incorporated or affixed to one planer or contoured surface can be rotated through a range of azimuth and elevation angles to track the Sun through its daily and seasonal range of motions. The heliostat 100 can be made substantially from a cementitious material, e.g., cast concrete or other inexpensive, high density, material having sufficient mass and rotational inertia to resist high frequency vibrations and wind gusts.

As mentioned above, the heliostat 100 includes the base member 102, transitional member 104 and the mirror member 106. The base member 102 is configured to secure to the Earth or a suitable foundation. A thrust bearing 108 can be included at an interface between the base member 102 and the transitional member 104. That is, a distal portion of the base member 102 can include a lower portion of the thrust bearing 108, which can allow other components mounted thereon to be rotated in azimuth, i.e., the direction indicated by the arrow 118. The transitional member 104 can include the upper portion of the thrust bearing 108. A goniometric cradle bearing 110 can be included at an interface between the transitional member 104 and the mirror member 106. That is, the transitional member 104 can further include a lower portion of the goniometric cradle bearing 110, that allows for angular translation of this member in elevation, indicated by the arrow 120. In other implementations, different mechanisms can be used for providing rotation in azimuth and elevation, and the thrust bearing 108 and goniometric cradle bearing 110 are examples. Other examples include a hinge, yoke, gimbal mechanism, and other devices capable of allowing controlled angular displacements.

The mirror member 106 includes a support portion 112 and a mirror portion 114. An upper portion of the goniometric cradle bearing 110 can be included in the support portion 112 of the mirror member 106. The goniometric cradle bearing 110 is configured such that the position of the mirror member 106 can be adjusted in elevation, e.g., to track the Sun as it moves across the sky through the course of a day. The mirror portion 114 can either be a reflective, i.e., mirrored, surface or can be configured for mounting a separate reflecting device. The mirror portion 114 can be adjusted in azimuth using the thrust bearing 108 and in elevation using the goniometric cradle bearing 110 so as to point at a desired azimuth and elevation angle to reflect the Sun's rays onto a specific target.

The mirror member 106 can be formed from a high density material and thereby provide the heliostat 100 with relatively high rotational inertia in azimuth and elevation. In some implementations, the mirror portion 114 of the mirror member 106 can be formed with a ribbed surface (generally the back surface) to reduce the volume of material used to make the component, thereby reducing the cost and the weight. In a particular example, the overall thickness of the mirror portion 114 can be approximately 1.5 to 2 inches at the thickest point (i.e., the apex of the ribs) and approximately 0.5 to 1 inches thick at the thinnest point (i.e., the bottom of the grooves formed between the ribs). In a particular example, the mirror portion 112 is approximately 3 feet by 6 feet in dimension.

In some implementations, the mirror 200 described above in reference to FIGS. 2A and 2B can form the mirror portion 114. That is, the mirror portion 114 can be formed from a substantially cementitious layer (i.e., base layer and mortar layer) with additional thin layers on top, i.e., the transition layer, reflective layer and a protective layer forming the exposed surface. The balance of the mirror member 106, i.e., the support portion 112, can also be formed from a cementitious material, which in some implementations is formed integral to the base layer of the mirror portion 114.

In some implementations, the transitional member 104 is also made from a high density material and the increased rotational inertia of the transitional member 104 will aid in the inertial stabilization of the heliostat 100. For example, the transitional member 104 can be formed from a cementitious material, e.g., foamed concrete. The transitional member 104 is formed as a substantially unitary member. That is, with the exception of the upper portion of the thrust bearing 108 and the lower portion of the goniometric cradle bearing 110, the remainder of the transitional member 104 can be a unitary member formed, for example, by molding. In the example shown in FIGS. 1A and 1B, the transitional member 104 includes two cradle portions 105a, 105b and the support portion 112 of the mirror member 106 includes two corresponding components configured to mate with the cradle portions 105a, 105b. A separate goniometric cradle bearing can be included at the interface of each cradle portion 105a, 105b and corresponding support portion 112, although a single goniometric cradle bearing that extends from one cradle portion across to the other can alternatively be used. In other implementations, the two cradle portions 105a, 105b are replaced by a single cradle portion that can mate with either two components of the support portion 112 or with a single support portion 112 that is approximately the width the of single cradle portion. In such an implementation, a single goniometric cradle bearing can be used. In other implementations, more than two cradle portions can be used that mate with one or more components of the support portion 112, and one or more goniometric cradle support bearings can be used to provide relative movement.

In some implementations, the base member 102 may also be cast in a high density material for convenience and cost reduction reasons, however generally the composition of the base member 102 will not provide any additional vibration or wind gust relief. The base member 102 can be formed as a pole that extends approximately 6-9 feet underground. In another example, the base member 102 can be formed relatively wide (e.g., as compared to a pole) and can be mounted to a concrete pad.

Preferably, the rotational centerline of each component passes directly through the particular component's center of gravity. In addition, preferably the force vector of any anticipated steady state winds will likewise pass directly through the heliostat's center of rotation. By these exercises of design geometry, the net forces applied to the heliostat 100 by gravity and the wind can be minimized. Additionally, the power required to move the transitional member 102 and mirror member 106, e.g., for Sun tracking purposes, can be reduced and relatively small prime movers can be applied through appropriate gearing.

The heliostat 100 is configured such that a lot of mass is arranged in a way that provides lots of rotational inertia. Before the heliostat 100 can move, e.g., due to wind or other environmental factors, the inertia of the heliostat 100 has to be overcome. In some implementations, as described, the mirror member 106 and optionally the transitional member 104 and/or the base member 102 can be formed from a high density material, such as a cementitious material, e.g., concrete, although another heavy material can be used. In another example, the material used is a plastic. In some implementations, the heliostat 100 can be configured to include a connected mass at a distance from the centers of rotation, which also has the effect of increasing the rotational inertia and therefore reducing the effect of wind.

In some implementations, some or all of the components of the heliostat 100 are manufactured by molding, which can reduce costs as compared to, for example, machining the components.

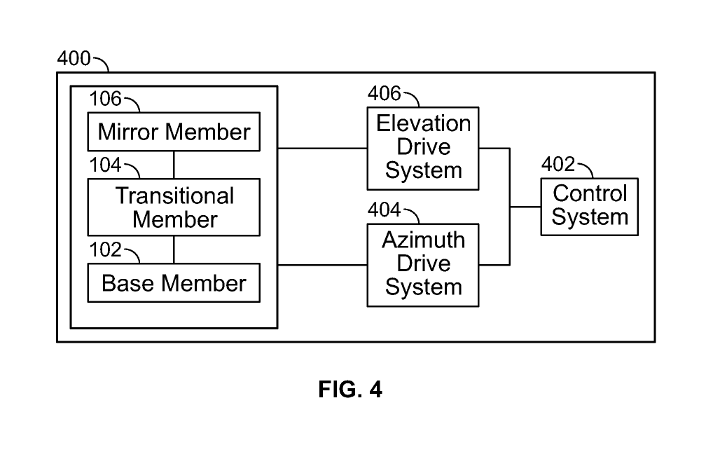

FIG. 4 is a block diagram representation of a heliostat 400. The heliostat system 400 includes the heliostat 100, a control system 402 and illustrates the drive systems to move the components of the heliostat 100. The heliostat 100 can be controlled by the control system 402 that can either be integral to the heliostat 100, separate but dedicated to the heliostat 100, remote from the heliostat 100 or a combination of the above. That is, the heliostat 100 can be controlled by a local controller that is in communication with a remote controller. The control system communicates with the drive systems to provide instructions to control movement of the heliostat 100 in azimuth and elevation. The control system can communicate with the heliostat 100 over a wired or wireless connection. The communication can occur using a network that can include one or more local area networks (LANs), a wide area network (WAN), such as the Internet, a wireless network, such as a cellular network, or a combination of all of the above.

The heliostat system 400 includes an azimuth drive system 404 and an elevation drive system 406. In some implementations, the azimuth drive system 404 can be implemented as a first motor that is coupled to the base member 102 and configured to turn a gear coupled to the transitional member 104. The first motor can be controlled by the control system 402, such that the first motor can be operated to rotate the transitional member 104 about the stationary base member 102, so as to change the direction the mirror portion 116 is pointing. In other implementations, the azimuth drive system 404 can be implemented as a first cable drive system, for example, that includes a cable around the transitional member 104 that can be operated to rotate the transitional member 104 about the stationary base member 102. Other forms of drive mechanism can be used, and the motor and cable drive are but a couple of examples. If the transitional member 104 is formed by molding, then features can be molded into the transitional member to accommodate the azimuth drive system 404. For example, gear teeth, keys or other features to allow gear teeth to affix to the member, e.g., lock/key features or bolt fastener apertures, can be molded into surfaces of the transitional member 104 and optionally the base member 102.

In some implementations, the elevation drive system 406 can be implemented as a second motor that is coupled to the transitional member 104 and configured to turn a gear coupled to the mirror member 106. The second motor can be controlled by the control system 402, such that the second motor can be operated to move displace the mirror member 106 in the direction indicated by the arrow 120 to change the elevation of the mirror portion 114. In other implementations, the elevation drive system 406 can be implemented as a second cable drive system. Other forms of drive mechanism can be used, and the motor and cable drive are but a couple of examples. If the transitional member 104 and/or mirror member 106 are formed by molding, then features can be molded into these members to accommodate the elevation drive system 406. For example, gear teeth, keys or other features to allow gear teeth to affix to the member, e.g., lock/key features or bolt fastener apertures, can be molded into surfaces of the transitional member 104 and/or the mirror member 106.

The control system 402 can be configured to control the position of the mirror member 106 based on the position of the Sun, which can be the actual position or a predicted position or both. For example, the position of the Sun can be predicted based on the location on Earth of the heliostat system 400, the time of day and the date of year. The desired azimuth and elevation of the heliostat 100 can be determined based on the predicted position of the sun and the relative position of the target, i.e., the receiver.

A number of embodiments have been described. Nevertheless, it will be understood that various modifications may be made without departing from the spirit and scope of the invention.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

What is claimed is:

1. A heliostat system comprising:
a base member adapted to be secured to a fixed surface;
a transitional member formed as a substantially unitary member, wherein a lower portion of the transitional member is coupled to the base member and an upper portion of the transitional member is coupled to a mirror member;
a first bearing coupling the base member and the transitional member, where a lower portion of the first bearing is included in the base member and an upper portion of the first bearing is included in the transitional member;
the mirror member including a support portion and a mirror portion, wherein the support portion is coupled to the transitional member;
a second bearing coupling the transitional member and the mirror member, wherein a first portion of the second bearing is included in the transitional member and a second portion of the second bearing is included in the support portion of the mirror member; and
a drive system that is configured to rotate the transitional member about the first bearing and to rotate the mirror member about the second bearing to change the azimuth and the elevation of the mirror member respectively.

2. The heliostat system of claim 1, wherein the support portion and the mirror portion of the mirror member are formed from a high density material.

3. The heliostat system of claim 1, wherein the first bearing is a thrust bearing and the drive system includes a motor to drive the thrust bearing.

4. The heliostat system of claim 1, wherein the second bearing is a goniometric cradle bearing and the drive system includes a motor to drive the goniometric cradle bearing.

5. The heliostat system of claim 1, wherein the drive system includes a first drive sub-system configured to rotate the transitional member about the first bearing and a second drive sub-system configured to rotate the mirror member about the second bearing.

6. The heliostat system of claim 1, wherein the base member is adapted to be secured to the Earth and includes a pole configured to mount within the Earth.

7. The heliostat system of claim 1, wherein the base member is adapted to be secured to a concrete pad formed on the Earth.

8. The heliostat system of claim 1, wherein the mirror portion comprises a mirror formed substantially from cementitious material and including a reflective layer.

9. The heliostat system of claim 1, wherein the support portion is formed substantially from cementitious material.

10. The heliostat system of claim 1, wherein the base member is formed substantially from cementitious material.

11. The heliostat system of claim 1, wherein the transitional member is formed substantially from cementitious material.

12. The heliostat system of claim 1, wherein a rotational centerline of each of the base member, transitional member and mirror member passes through the respective member's center of gravity.

13. A heliostat system comprising;
a base member adapted to be secured to a fixed surface, wherein a lower portion of a thrust bearing is included at a distal portion of the base member;
a transitional member formed as a substantially unitary member cast from a high density material, wherein:
an upper portion of the thrust bearing is included at a lower portion of the transitional member, which is coupled to the base member, and
a lower portion of a goniometric cradle bearing is included at an upper portion of the transitional member, which is coupled to a mirror member;
the mirror member including a support portion and a mirror portion, wherein:
the support portion includes an upper portion of the goniometric cradle bearing and is coupled to the transitional member; and
a drive system that is configured to rotate the transitional member about the thrust bearing and to rotate the mirror member about the goniometric cradle bearing to change the azimuth and the elevation of the mirror portion of the mirror member.

14. The heliostat system of claim 13, wherein a rotational centerline of each of the base member, transitional member and mirror member passes through the respective member's center of gravity.

15. The heliostat system of claim 13, wherein the mirror member is formed from a high density material.

16. The heliostat system of claim 15, wherein the high density material comprises a cementitious material.

17. The heliostat system of claim 13, wherein the base member is formed from a cementitious material.

18. The heliostat system of claim 13, wherein the transitional member is formed from a cementitious material.
